(19) United States
(12) Patent Application Publication
(10) Pub. No.: US 2023/0171128 A1
(43) Pub. Date: Jun. 1, 2023

(54) METHOD AND APPARATUS FOR JOINT COMMUNICATION AND SENSING IN A MOBILE COMMUNICATION SYSTEM

(71) Applicant: MEDIATEK INC., Hsin-Chu (TW)

(72) Inventors: Chien-Hwa Hwang, Hsin-Chu (TW); Jiann-Ching Guey, Hsin-Chu (TW)

(21) Appl. No.: 17/978,961

(22) Filed: Nov. 1, 2022

Related U.S. Application Data
(60) Provisional application No. 63/284,694, filed on Dec. 1, 2021.

(51) Int. Cl. H04L 25/02; H04L 5/00

(52) U.S. Cl. CPC H04L 25/0224; H04L 5/005; H04L 5/0007

(57) ABSTRACT

Method and apparatus are provided for joint communication and sensing with same radio resource in a mobile communication system. An apparatus can receive a common signal from a network node. The apparatus can use the common signal as a pilot signal to perform a channel estimation. The apparatus can use the common signal as a sensing signal to perform a sensing. The common signal comprises the pilot signal and the sensing signal.

### CROSS REFERENCE TO RELATED APPLICATIONS

This application claims priority under 35 U.S.C. §119 from U.S. Provisional Application Number 63/284,694, entitled “Joint Communication and Sensing with Same Radio Resource,” filed on Dec. 1, 2021, the subject matter of which is incorporated herein by reference.

### TECHNICAL FIELD

The disclosed embodiments relate generally to wireless communication, and, more particularly, to method and apparatus for joint communication and sensing with same radio resource in a mobile communication system.

### BACKGROUND

In conventional wireless communication systems such as 3rd generation partnership project (3GPP) 5G new radio (NR), the time-frequency resources of orthogonal frequency division multiplexing (OFDM) system are used to carry communication signals between the user equipment (UE) and the network node. Currently, no sensing signals are carried in the time-frequency resources of OFDM system.

With the development of a new communication system (e.g., 6G), more applications will be introduced to enhance the utilities of the communication network. For example, more sensing technologies will be applied within the communication system. The UE and the network node may be designed to support a variety of sensing applications such as weather condition sensing, air quality sensing, velocity sensing, position sensing, etc. Therefore, more and more sensing signals need to be communicated between the devices within a communication system.

However, the current OFDM system are not designed for carrying sensing signals or support sensing technologies. The spectrum/radio resources allocation for both communication and sensing will become an important issue in a newly developed communication system. Thus, there is a need to provide proper schemes to accommodate both communication signals and sensing signal with high spectrum efficiency in a communication system.

### SUMMARY

Method and apparatus are provided for joint communication and sensing with same radio resource in a mobile communication system. In one aspect, an apparatus can receive a common signal from a network node. The apparatus can use the common signal as a pilot signal to perform a channel estimation. The apparatus can use the common signal as a sensing signal to perform a sensing. The common signal comprises the pilot signal and the sensing signal.

In another aspect, a network node can transmit a common signal to an apparatus. The network node can receive a communication signal from the apparatus in response to the common signal. The network node can receive a sensing feedback from the apparatus in response to the common signal. The common signal comprises a pilot signal for the communication signal and a sensing signal for the sensing feedback.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates an exemplary wireless communication network supporting joint communication and sensing with same radio resource in accordance with embodiments of the current invention.

FIG. 2 is a simplified block diagram of the BS and the UE in accordance with embodiments of the current invention.

FIG. 3 illustrates exemplary time-frequency resources of an OFDM system in accordance with embodiments of the current invention.

FIG. 4 illustrates exemplary scenarios under schemes in accordance with embodiments of the current invention.

FIG. 5 is a flow chart of a method of joint communication and sensing with same radio resource for an apparatus in accordance with embodiments of the current invention.

FIG. 6 is a flow chart of a method of joint communication and sensing with same radio resource for a network node in accordance with embodiments of the current invention.

### DETAILED DESCRIPTION

Reference will now be made in detail to some embodiments of the invention, examples of which are illustrated in the accompanying drawings.

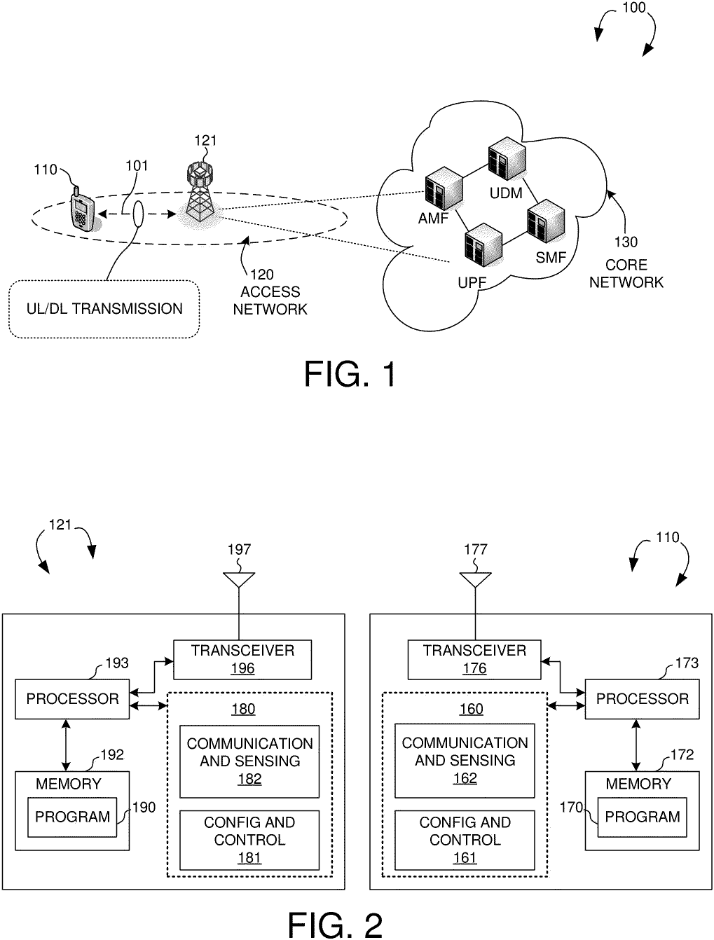

FIG. 1 illustrates an exemplary wireless communication network 100 (e.g., 6G network) supporting joint communication and sensing with same radio resource in accordance with embodiments of the current invention. The 6G network 100 includes a user equipment (UE) 110 communicatively connected to a base station (BS) 121 operating in a licensed band (e.g., 30 GHz~300 GHz) of an access network 120 which provides radio access using a Radio Access Technology (RAT). The access network 120 is connected to a core network 130 by means of the NG interface, more specifically to a User Plane Function (UPF) by means of the NG user-plane part (NG-u), and to a Mobility Management Function (AMF) by means of the NG control-plane part (NG-c). One base station can be connected to multiple UPFs/AMFs for the purpose of load sharing and redundancy. The UE 110 may be a smart phone, a wearable device, a vehicle, an Internet of Things (IoT) device, and a tablet, etc. Alternatively, UE 110 may be a Notebook (NB) or Personal Computer (PC) inserted or installed with a data card which includes a modem and RF transceiver(s) to provide the functionality of wireless communication.

The BS 121 may provide communication coverage for a geographic coverage area in which communications with the UE 110 is supported via a communication link 101. The communication link 101 shown in the 6G network 100 may include UL transmissions from the UE 110 to the BS 121 (e.g., on the Physical Uplink Control Channel (PUCCH) or Physical Uplink Shared Channel (PUSCH)) or downlink (DL) transmissions from the BS 121 to the UE 110 (e.g., on the Physical Downlink Control Channel (PDCCH) or Physical Downlink Shared Channel (PDSCH)).

FIG. 2 is a simplified block diagram of the BS 121 and the UE 110 in accordance with embodiments of the present invention. For the BS 121, an antenna 197 transmits and receives radio signal. A radio frequency (RF) transceiver module 196, coupled with the antenna, receives RF signals from the antenna, converts them to baseband signals and sends them to processor 193. RF transceiver 196 also converts received baseband signals from the processor 193, converts them to RF signals, and sends out to antenna 197. Processor 193 processes the received baseband signals and invokes different functional modules and circuits to perform features in the BS 121. Memory 192 stores program instructions and data 190 to control the operations of the BS 121.

Similarly, for the UE 110, antenna 177 transmits and receives RF signals. RF transceiver module 176, coupled with the antenna, receives RF signals from the antenna, converts them to baseband signals and sends them to processor 173. The RF transceiver 176 also converts received baseband signals from the processor 173, converts them to RF signals, and sends out to antenna 177. Processor 173 processes the received baseband signals and invokes different functional modules and circuits to perform features in the UE 110. Memory 172 stores program instructions and data 170 to control the operations of the UE 110.

The BS 121 and the UE 110 also include several functional modules and circuits that can be implemented and configured to perform embodiments of the present invention. In the example of FIG. 2, the BS 121 includes a set of control functional modules and circuit 180. Communication and sensing circuit 182 handles joint communication and sensing. Configuration and control circuit 181 provides different parameters to configure and control the UE 110. The UE 110 includes a set of control functional modules and circuit 160. Communication and sensing circuit 162 handles joint communication and sensing. Configuration and control circuit 161 handles configuration and control parameters from the BS 121.

Note that the different functional modules and circuits can be implemented and configured by software, firmware, hardware, and any combination thereof. The function modules and circuits, when executed by the processors 193 and 173 (e.g., via executing program codes 190 and 170), allow the BS 121 and the UE 110 to perform embodiments of the present invention.

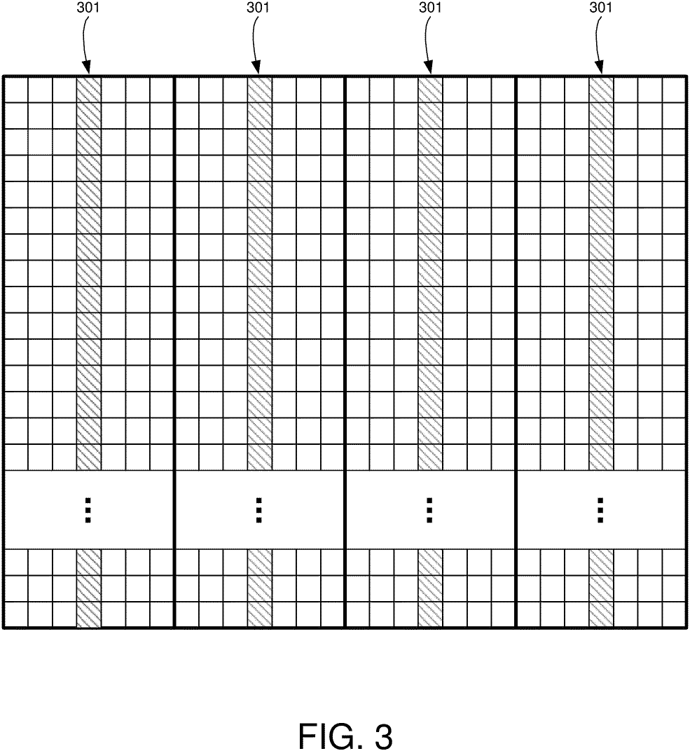

FIG. 3 illustrates exemplary time-frequency resources of an OFDM system in accordance with one novel aspect. The horizontal axes represent the time domain. The vertical axes represent the frequency domain. Over the time domain, the resource is partitioned into multiple OFDM symbols. Over the frequency domain, the resource is partitioned into multiple subcarriers. Each rectangle composed of one OFDM symbol and one subcarrier is called a resource element of the OFDM system. The resource elements 301 marked with diagonal lines are used for the transmission of a signal which serves the purpose of pilot signal for communication as well as sensing signal fore sensing. Other resource elements (e.g., without diagonal lines) can be used for transmission and reception of symbols for communication (e.g., downlink data or uplink data) .

In the wireless communication system in accordance with one novel aspect, the functionalities of communication and sensing can utilize the same time-frequency resources (e.g., the same resource elements) to perform their works individually and simultaneously. In other words, the same resource elements can be used to carry a common signal for both communication and sensing. In particular, a common signal such as a chirp signal given as s(t) ∝ e^{jπµ1t2} can be used as the pilot signal for communication as well as the sensing signal for sensing. The chirp signal may comprise an equation (e.g., a polynomial of cosine) which is a function of square of time. In one embodiment, the resource elements 301 are used/allocated to carry the chirp signal. The same chirp signal may comprise two functionalities. The same chirp signal can be used as the pilot signal and the sensing signal for an apparatus in the wireless communication system.

Specifically, at the receiver side, an apparatus (e.g., a UE or a device) may be configured to receive the common signal from a network node. The apparatus may use the common signal as a pilot signal to perform a channel estimation. The pilot signal may comprise a reference signal or a broadcasted signal for channel estimation. The apparatus may use the common signal as a sensing signal to perform a sensing. The sensing signal may comprise any signals for sensing purpose. The common signal may comprise or have the functionalities of the pilot signal and the sensing signal. The pilot signal and the sensing signal may be the same signal.

For the functionality of communication, the common signal can be used by the receiver for estimating the channel state information (CSI), tracking the time and/or frequency of the received signal, estimating the channel for signal demodulation, etc. For the functionality of sensing, the common signal can be used by the receiver for estimating the location and/or velocities of an object (e.g., a surrounding object), monitoring the weather condition, monitoring the air quality, monitoring the temperature etc. The common signal may also be used for optical detection or sonic detection.

On the other hand, at the transmitter side, a network node may be configured to transmit the common signal to an apparatus (e.g., a UE or a device). The network node may use the common signal as a pilot signal for channel estimation. The pilot signal may comprise a reference signal or a broadcasted signal for channel estimation. The network node may further receive a communication signal from the apparatus in response to the common signal. The network node may use the common signal as a sensing signal for sensing. The sensing signal may comprise any signals for sensing purpose. The network node may further receive a sensing feedback from the apparatus in response to the common signal.

The common signal may comprise or have the functionalities of the pilot signal and the sensing signal. The pilot signal and the sensing signal may be the same signal. Using the common signal as the pilot signal and the sensing signal simultaneously is a new design in accordance with one novel aspect of the present disclosure. The pilot signal can be used for at least one of CSI estimation, time or frequency tracking and channel estimation for signal demodulation. The sensing signal can be used for at least one of location or velocity estimation of an object, weather condition monitoring and air quality monitoring. The network node may transmit the common signal on a time-frequency resource of an OFDM system. The common signal may comprise a chirp signal which is a function of square of time. Since the same time-frequency resource can be used for multiple functionalities (e.g., communication and sensing), the spectrum efficiency will be increased/improved. More applications may be developed with limited radio resources.

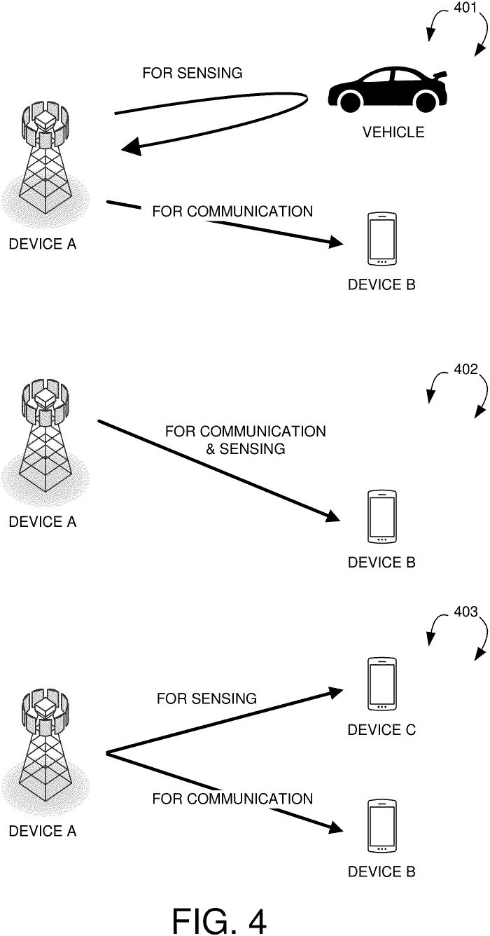

FIG. 4 illustrates exemplary scenarios under schemes in accordance with embodiments of the present disclosure. In scenario 401, the receiver of communication signal is device B. The receiver of sensing signal is device A. Specifically, device A (e.g., a base station or a network node) may be configured to transmit the chirp signal for both communication and sensing. The chirp signal is received by device B (e.g., a UE) for communication. Device B may use the chirp signal to perform channel estimation or measurement. Device B may further transmit a CSI report or a measurement report to device A. On the other hand, the chirp signal is received by a vehicle for sensing. When the chirp signal reaches the vehicle, there will be a sensing feedback signal reflected by the vehicle. Then, device A may receive the sensing feedback signal for sensing. For example, device A may detect/calculate the velocity or position of the vehicle according to the sensing feedback signal. Accordingly, device A may use the same chirp signal to communication with device B and sensing the vehicle simultaneous by using the same resource elements.

In scenario 402, the receivers of communication signal and sensing signal are both device B. Specifically, device A (e.g., a base station or a network node) may be configured to transmit the chirp signal for both communication and sensing. The chirp signal is received by device B (e.g., a UE) for communication and sensing. Device B may use the chirp signal to perform channel estimation or measurement. Device B may further transmit a CSI report or a measurement report to device A. On the other hand, the chirp signal is also received by device B for sensing. Device B may use the chirp signal to detect the weather condition, the air quality, the temperature, etc. Device B may further transmit a sensing result to device A or use the sensing result by itself. Similarly, when the chirp signal reaches device B, there will be a sensing feedback signal reflected by device B. Then, device A may receive the sensing feedback signal for sensing. For example, device A may detect/calculate the velocity or position of device B according to the sensing feedback signal.

In scenario 403, the receiver of communication signal is device B. The receiver of sensing signal is device C. Specifically, device A (e.g., a base station or a network node) may be configured to transmit the chirp signal for both communication and sensing. The chirp signal is received by device B (e.g., a UE) for communication. Device B may use the chirp signal to perform channel estimation or measurement. Device B may further transmit a CSI report or a measurement report to device A. On the other hand, the chirp signal is received by device C (e.g., a UE) for sensing. Device C may use the chirp signal to detect the weather condition, the air quality, the temperature, etc. Device C may further transmit a sensing result to device A or use the sensing result by itself. Similarly, when the chirp signal reaches device C, there will be a sensing feedback signal reflected by device C. Then, device A may receive the sensing feedback signal for sensing. For example, device A may detect/calculate the velocity or position of device C according to the sensing feedback signal.

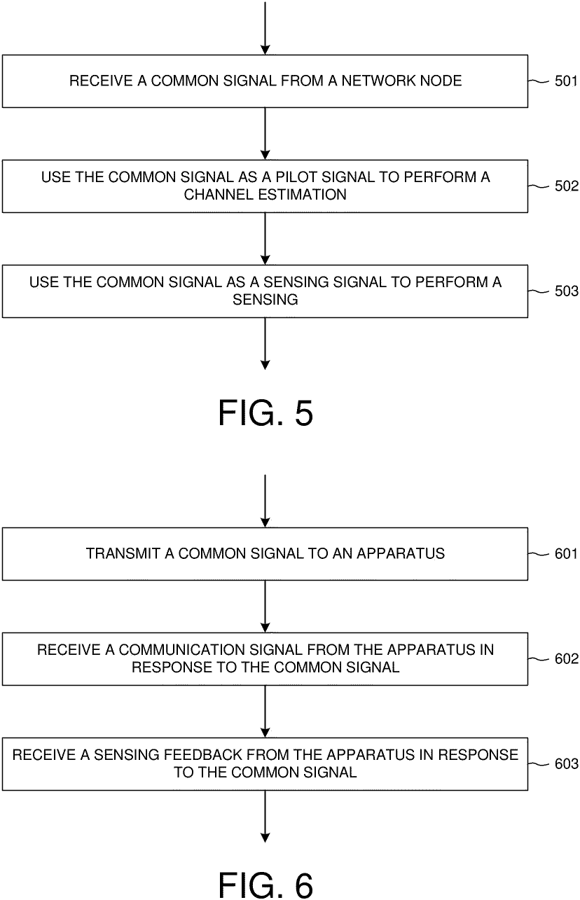

FIG. 5 is a flow chart of a method of joint communication and sensing with same radio resource in accordance with one novel aspect. In step 501, an apparatus (e.g., a receiver) receives a common signal from a network node. The common signal comprises a pilot signal and a sensing signal. In step 502, the apparatus uses the common signal as the pilot signal to perform a channel estimation. In step 503, the apparatus uses the common signal as the sensing signal to perform a sensing.

In one implementation, the channel estimation comprises at least one of CSI estimation, time or frequency tracking and channel estimation for signal demodulation.

In one implementation, the sensing comprises at least one of location or velocity estimation of an object, weather condition monitoring and air quality monitoring.

In one implementation, the common signal is carried on a time-frequency resource of an OFDM system. In one implementation, the common signal comprises a chirp signal which is a function of square of time.

FIG. 6 is a flow chart of a method of joint communication and sensing with same radio resource in accordance with one novel aspect. In step 601, a network node (e.g., a transmitter) transmits a common signal to an apparatus. In step 602, the network node receives a communication signal from the apparatus in response to the common signal. In step 603, the network node receives sensing feedback from the apparatus in response to the common signal. The common signal comprises a pilot signal for the communication signal and a sensing signal for the sensing feedback.

In one implementation, the pilot signal can be used for at least one of CSI estimation, time or frequency tracking and channel estimation for signal demodulation.

In one implementation, the sensing signal can be used for at least one of location or velocity estimation of an object, weather condition monitoring and air quality monitoring.

In one implementation, the network node transmits the common signal on a time-frequency resource of an OFDM system. In one implementation, the common signal comprises a chirp signal which is a function of square of time.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
receiving, by an apparatus, a common signal from a network node;
using, by the apparatus, the common signal as a pilot signal to perform a channel estimation; and
using, by the apparatus, the common signal as a sensing signal to perform a sensing,
wherein the common signal comprises the pilot signal and the sensing signal.

2. The method of claim 1, wherein the channel estimation comprises at least one of channel state information (CSI) estimation, time or frequency tracking and channel estimation for signal demodulation.

3. The method of claim 1, wherein the sensing comprises at least one of location or velocity estimation of an object, weather condition monitoring and air quality monitoring.

4. The method of claim 1, wherein the common signal is carried on a time-frequency resource of an orthogonal frequency division multiplexing (OFDM) system.

5. The method of claim 1, wherein the common signal comprises a chirp signal which is a function of square of time.

6. A method, comprising:
transmitting, by a network node, a common signal to an apparatus;
receiving, by the network node, a communication signal from the apparatus in response to the common signal; and
receiving, by the network node, a sensing feedback from the apparatus in response to the common signal,
wherein the common signal comprises a pilot signal for the communication signal and a sensing signal for the sensing feedback.

7. The method of claim 6, wherein the pilot signal can be used for at least one of channel state information (CSI) estimation, time or frequency tracking and channel estimation for signal demodulation.

8. The method of claim 6, wherein the sensing signal can be used for at least one of location or velocity estimation of an object, weather condition monitoring and air quality monitoring.

9. The method of claim 6, wherein the transmitting comprises transmitting the common signal on a time-frequency resource of an orthogonal frequency division multiplexing (OFDM) system.

10. The method of claim 6, wherein the common signal comprises a chirp signal which is a function of square of time.

11. An apparatus comprising:
a receiver that:
receives a common signal from a network node;
a processor that:
uses the common signal as a pilot signal to perform a channel estimation; and
uses the common signal as a sensing signal to perform a sensing,
wherein the common signal comprises the pilot signal and the sensing signal.

12. The apparatus of claim 11, wherein the processor performs at least one of channel state information (CSI) estimation, time or frequency tracking and channel estimation for signal demodulation when performing the channel estimation.

13. The apparatus of claim 11, wherein the processor performs at least one of location or velocity estimation of an object, weather condition monitoring and air quality monitoring when performing the sensing.

14. The apparatus of claim 11, wherein the receiver receives the common signal on a time-frequency resource of an orthogonal frequency division multiplexing (OFDM) system.

15. The apparatus of claim 11, wherein the common signal comprises a chirp signal which is a function of square of time.

16. A network node comprising:
a transmitter that:
transmits a common signal to an apparatus;
a receiver that:
receives a communication signal from the apparatus in response to the common signal; and
receives a sensing feedback from the apparatus in response to the common signal,
wherein the common signal comprises a pilot signal for the communication signal and a sensing signal for the sensing feedback.

17. The network node of claim 16, wherein the pilot signal can be used for at least one of channel state information (CSI) estimation, time or frequency tracking and channel estimation for signal demodulation.

18. The network node of claim 16, wherein the sensing signal can be used for at least one of location or velocity estimation of an object, weather condition monitoring and air quality monitoring.

19. The network node of claim 16, wherein, in transmitting the common signal, the transmitter transmits the common signal on a time-frequency resource of an orthogonal frequency division multiplexing (OFDM) system.

20. The network node of claim 16, wherein the common signal comprises a chirp signal which is a function of square of time.
